(19) United States
(12) Patent Application Publication
(10) Pub. No.: US 2015/0282499 A1
(43) Pub. Date: Oct. 8, 2015

(54) JELLY CONFECTION AND METHOD FOR PRODUCING SUCH A CONFECTIONERY PRODUCT

(71) Applicant: ROQUETTE FRERES, LESTREM (FR)

(72) Inventors: Sylvie Lagache, Marcq En Baroeul (FR); Raymond Brendel, Bethune (FR); Daniel Guerard, Bethune (FR)

(21) Appl. No.: 14/442,847

(22) PCT Filed: Nov. 14, 2013
(86) PCT No.: PCT/FR2013/052748

§ 371 Date: May 14, 2015

(30) Foreign Application Priority Data
Nov. 14, 2012 (FR) 1260847

(51) Int. Cl. A23G 3/42; A23G 3/48; A23G 3/38

(52) U.S. Cl. CPC A23G 3/42; A23G 3/38; A23G 3/48; A23V 2002/00

(57) ABSTRACT

The present invention concerns a novel jelly confection, and more particularly a chewy sweet or a chewing gum comprising a gelatinising agent providing said sweets with the chewiness of same. More particularly, the present invention concerns a novel jelly confection containing little or no gelatin. The present invention also concerns a method for preparing such a confection.

### FIELD OF THE INVENTION

The present invention relates to a novel jelly confectionery, more particularly a piece of soft candy or a chewing paste comprising a gelatinizing agent which gives said pieces of candy their chewability. More particularly, the present invention relates to a novel jelly confectionery containing little or no gelatin. The present invention also relates to a process for preparing such a confectionery.

### TECHNICAL BACKGROUND

There are many confectionery products. They all have in common the boiling of sugar and the mixing thereof with other ingredients in order to obtain different specialty products and fragrances. For the purposes of the present invention, the term “jelly confectionery” is intended to mean gums, chewing pastes and jellies, which belong to soft articles compared with hard boiled candies, and also caramels, toffees, fudges, pastilles, fondants and fillings conventionally containing gelatin. These confectioneries consist in particular of sugars or polyols, sweeteners, fat, emulsifiers, flavors, dyes, inorganic and/or organic acids and/or bases and salts thereof, and one or more thickening and/or gelling hydrocolloids of vegetable or animal origin, such as gum arabic, gelatin, pectin, carrageenans, alginates, celluloses and starch. There are no precise definitions of these various jelly confectioneries, which can be arbitrarily characterized as hard gums and soft gums. The hard gums (fruit gums, licorice gums, pastilles) are, for example, fruit gums, mint gums and licorice gums. These gums are conventionally produced based on gum arabic and/or starch used as thickener. They are hard and not very tacky and dissolve slowly in the mouth. The soft gums group together jellies and gums (jelly beans, wine gums), conventionally prepared based on gelatin and/or starch used as gelling agent and providing the required elasticity for these soft articles, of elastic to plastic texture. The soft gums conventionally also comprise jellies based on pectin and based on carrageenans or agar-agar.

Hard or soft jelly confectioneries are generally produced by boiling a mixture which generally comprises a mixture of sugar(s) or polyol(s) and of glucose or maltitol syrup, or more generally hydrogenated glucose syrup, to which a thickener or gelling agent, flavors, acids, dyes and strong sweeteners are added after boiling. The boiled and flavored mixture is then generally cast in molds or in molding starch, and then usually (but not necessarily) stoved so as to obtain drying and setting of the gel before recovery of the final article.

Chewing pastes are obtained by boiling a mixture of sugar and glucose syrup, to which a small amount of fat has been added. The boiled mass is then aerated in order to lighten it by means of one of the processes well known to confectioners, for instance pulling, beating, optionally under pressure, mixing under pressure, or extrusion. It is this aeration and the presence of fats which give chewing pastes their characteristic texture.

The present invention also concerns caramels, toffees, fudges, pastilles and fillings conventionally containing gelatin.

The composition of caramels, toffees and fudges can vary to a large extent according to the desired strength of color and taste and also the desired texture. Generally, the residual moisture content of such products varies between 3% and 10%, sucrose between 30% and 60%, invert sugar between 1% and 10%, glucose syrup (expressed on a dry basis) between 20% and 50%, fats between 1% and 15%, lactose between 1% and 6% and milk proteins between 0.75% and 15%.

Technologically, it is possible to categorize these specialty products in three main groups according to their residual moisture content and their texture. Hard caramels have a residual moisture content of 3% to 4% and a hard and smooth texture, whereas soft caramels/toffees have a relative moisture content of 7% to 10% and a soft and chewy texture, and fudges have a residual moisture content of 7% to 9% for a soft but short texture. The names “(soft or hard) caramels” and “toffees”, possibly accompanied by a description, are reserved for confectioneries prepared by boiling sugar, glucose (or invert sugar), dietary fats (butyric fat, vegetable fat and/or animal fat) and milk proteins, the fats and the milk proteins having to be in proportions such that the final product contains at least 6% of fats and 6% of solids originating from milk.

Fatty fillings are all mixtures obtained from sugar, or from any other bulk sweetener, for instance polyols, and from vegetable and/or animal fats, which conventionally contain milk proteins and which are intended to be used as filling in confectionery, cake production, the bakery trade, the cookie trade and any other area of food production. Such examples are, for example, praline-flavored fatty fillings and imitation “chocolate” fatty fillings.

The gelatin used in all these jelly confectioneries is an animal protein extracted, after partial hydrolysis, from raw materials rich in collagen extracted from skin, bone, cartilage, ligaments, etc.

Three raw materials are used nowadays to industrially obtain gelatin: pig skins which are always treated by acid hydrolysis and which produce type A gelatins, bovine skins which are always treated by alkaline hydrolysis and which produce type B gelatins, and bones which may be of type A or B. Whether the hydrolysis has been carried out in an acidic or alkaline medium, the gelatin is then extracted with hot water at increasing temperatures. Filtration, deionization, concentration, sterilization, gelling, extrusion, drying and grinding operations are then carried out, making it possible to obtain the final product.

Gelatin produced from fish also exists, but it represents only a very small percentage of the food gelatin produced today in Europe (less than 3%).

Once it is ready to use, gelatin is a translucent, transparent or slightly yellow solid substance which has a characteristic odor and taste.

After dissolution in hot water and cooling, gelatin forms a semi-solid colloidal gel which has many advantages for food applications:
it is very clear, and this transparency is desired in particular in the confectionery sector,
it is reversible, i.e. it melts when it is heated above a temperature termed melting point which is between 27° C. and 35° C., which is advantageous when melting in the mouth is desired.

The formation of the gel will depend:
on the gelatin itself (bloom value),
on the duration and the temperature: the gel forms immediately at 10° C., but approximately 16 hours are necessary in order to achieve maximum gelling,
and on the gelatin concentration: it must be at least 0.8% in order for there to be gelling; this is what is called the critical gelling concentration.

Gelatin is very widely used in the confectionery field. It is its elasticity which is highly appreciated since it provides a very particular sensation upon chewing. It also has excellent abilities to release flavors, hence its value for producing delicious confectioneries. Finally, it is capable of absorbing five to six times its weight in water. It is therefore very widely used since it has many functional assets. It is used first and foremost as a gelling agent, but also as a thickener, stabilizer, emulsifier, binder and firming agent in aerated confectioneries.

For many years, gelatin has hardly had good press. Following the emergence of bovine spongiform encephalitis, the use of gelatin in food preparations is today very controversial. In addition, in the confectionery field, only gelatin derived from pig skins is used, which can also pose problems with respect to certain beliefs or religions. Finally, vegetarians and vegans also refuse to consume any products derived from animals and consequently boycott all confectioneries containing gelatin.

Furthermore, because of its taste and its particular odor, its use very often forces manufacturers to use flavors in order to mask its presence and its olfactory drawbacks.

Gelatin also has a high cost price which can curb its use, in particular for emerging countries.

Furthermore, gelatin is a protein that is very sensitive to extreme pH and temperature conditions (very acidic pHs, very high temperatures) in which it has a tendency to degrade, thus losing its gelling properties.

A very large number of research studies have been carried out in order to propose more or less complex solutions for totally or partially replacing gelatin in the production of jelly confectioneries. Jelly confectioneries based on various starches are in particular known.

For example, document U.S. Pat. No. 3,218,177 proposed, more than thirty years ago, the use of high-amylose starches and in particular corn starches as the one and only thickener. Only amylose contents greater than 40% made it possible to prepare satisfactory confectioneries, but such starches required very high cooking temperatures, above 150° C. (approximately 165° C. to 170° C. for a gum formula) and very high vapor pressures, therefore specific equipment with which confectioners are not generally equipped. Furthermore, high-amylose starches retrograde strongly after cooking, thus generating a loss of transparency, and pose casting viscosity problems.

Those skilled in the art know, moreover, that only amylose acts as a gelling agent, that amylopectin confers elasticity on products but gels more slowly and increases casting viscosity much more than amylose, and that amylose gives opaque gels whereas amylopectin gives transparent products.

It has therefore been proposed, in documents EP 0 252 306 B1 and EP 0 360 046 B1, to mix various modified or unmodified high-amylose starches so as to combine the properties thereof. These solutions require mixtures of several starches and are not necessarily simple to use industrially speaking.

It was therefore recognized that only high-amylose starches made it possible to obtain confectioneries with a satisfactory texture, close to confectioneries containing gelatin, particularly when they contained a mixture of high-amylose starch and starch that is fluid when hot. The advantage of high-amylose starches has, moreover, been widely commented upon in the document “Confectionary manufacture and Marketing, vol. 24, No. 6, 1987, pages 2, 4 and 6”.

Document EP 0 591 473 B1 describes the mixture of thinned or oxidized common corn starches and acid-thinned high-amylose starch. The use of approximately 1% of modified starches has also been described entirely generally in combination with a mixture of iota- and kappa-carrageenans in document WO 00/19836, the best results being obtained, however, with the gelling systems composed only of carrageenans. These systems then prove to be relatively expensive.

Document EP 1 342 417 A, of which the applicant is the proprietor, describes a jelly confectionery containing a waxy starch in combination with carrageenans. The confectioneries obtained are of satisfactory quality but do not equal the properties of the confectioneries obtained with gelatin, and the solution proposed imposes the use of carrageenans which are expensive.

Finally, document EP 1 645 196 B, of which the applicant is also the proprietor, describes jelly confectioneries with a base of liquefied and stabilized starch of a leguminous plant having quite a specific amylose content.

All the routes proposed and described in the prior art for totally or partially replacing gelatin in jelly confectioneries do not make it possible either to obtain textures comparable to the standard jelly confectioneries containing gelatin, or to use a simple, rapid and inexpensive production process.

What is more, one of the major problems with which confectioners are confronted during the production of starch confectioneries is the evaporation of the water contained in the cooked mixture by stoving of said confectioneries, which quite often proves to be very lengthy, because starches allow processing only at low solids content. A reduction in this stoving time is therefore desired by confectioners.

The thermal stability of the confectioneries obtained is also one of the major preoccupations, especially when said confectioneries are intended for hot countries. The strongest resistance to melting is thus desired in order to be sure of the stability of the confectioneries over time.

There was therefore a need for a starch capable of totally or partially replacing gelatin in jelly confectioneries, and capable of developing a low viscosity under hot conditions, thus making it possible to work at a high solids content and at a cooking temperature that is not too high, capable of rapidly forming a gel, allowing easy removal of the articles from the mold, making it possible, when it was necessary, to eliminate the prior stoving step, and conferring on the confectioneries the desired qualities which are: a satisfactory visual appearance, an absence of tacking nature either in the mouth or in the final packaging, a texture in the mouth that is as close as possible to the starch-free control, and satisfactory stability with respect to hardness or melting over time.

### SUMMARY OF THE INVENTION

Armed with this finding and after numerous research studies, it is to the credit of the applicant company to have satisfied all the demands required and have found that such an objective can be achieved provided that a particular starch is used as thickener or gelling agent. It is therefore to the credit of the applicant to have discovered that a pregelatinized waxy starch can, surprisingly and unexpectedly with respect to the prerequisites of the prior art, advantageously replace gelatin in jelly confectioneries, while at the same time preserving the organoleptic qualities, in particular gustative, olfactory, visual and tactile properties, at least equivalent to or even greater than those of the conventional confectioneries containing gelatin.

Thus, a subject of the present invention is the use of a pregelatinized waxy starch for replacing gelatin in jelly confectioneries traditionally made with gelatin. Despite this replacement, the confectioneries retain a texture, a chewability, a duration in the mouth and a palatability that are at least similar, or even improved, compared with the confectioneries conventionally comprising gelatin. The gelatin may be partially or totally replaced.

A subject of the present invention is also a novel jelly confectionery comprising from 0.1% to 25% of pregelatinized waxy starch, preferably from 2% to 10%, even more preferably 4% to 8%, the percentages being expressed by weight relative to the total weight of the confectionery.

The present invention also relates to a jelly confectionery comprising a pregelatinized waxy starch and at least one other ingredient chosen from Nutriose, sorbitol and glycerol.

In addition, the present invention also relates to a process for preparing such a confectionery.

### DETAILED DESCRIPTION OF THE EMBODIMENTS

A subject of the present invention is the use of a pregelatinized waxy starch having an amylopectin content greater than or equal to 80%, for partially or totally replacing gelatin in jelly confectioneries conventionally made with gelatin.

The subject of one preferred embodiment of the invention is the use of a pregelatinized waxy starch having an amylopectin content greater than or equal to 90%, for partially or totally replacing gelatin in jelly confectioneries conventionally made with gelatin.

The subject of an even more preferred embodiment of the invention is the use of a pregelatinized waxy starch having an amylopectin content greater than or equal to 95%, for partially or totally replacing gelatin in jelly confectioneries conventionally made with gelatin.

A subject of the present invention is therefore also a novel jelly confectionery containing little or no gelatin, characterized in that it comprises a pregelatinized or precooked waxy starch.

The present invention therefore relates to a novel jelly confectionery comprising from 0.1% to 25% of pregelatinized waxy starch, preferably from 2% to 10%, even more preferably 4% to 8%, the percentages being expressed by weight relative to the total weight of the confectionery.

According to the present invention, the expression “jelly confectionery” should be interpreted as denoting all confectioneries usually containing gelatin. They are, inter alia, hard gums, soft gums, chewing pastes, licorices, jellies, pastilles, fruit pastes, caramels, toffees, fondants, fudges and fillings, lozenges, and also inclusions for ice creams or cakes, or else any of the confectioneries of the same type which are termed pharmaceutical and which contain an active ingredient for example. All these articles form part of the soft articles compared with hard boiled candies.

In one preferred embodiment of the present invention, the jelly confectioneries are chewing pastes which are very well-liked by consumers because of their considerable chewability property making them similar to a chewing gum.

It is to the credit of the applicant to have found that the use of a pregelatinized waxy starch in a jelly confectionery formula usually containing gelatin makes it possibly to partially or totally replace this compound of animal origin while at the same time making it possible to obtain confectioneries having all the organoleptic and physical characteristics of a jelly confectionery containing gelatin.

Starch is the main storage carbohydrate substance of higher plants. It is a homopolymer of D-glucose. Starch is composed of two polymers of different primary structure: amylose, an essentially linear molecule composed of D-glucose units linked together by linkages of αD(1,4) type, and amylopectin, a branched molecule in which the D-glucose units are polymerized via αD(1,4) linkages and are linked with αD(1,6) branchings. Depending on its botanic origin, starch exhibits variations in composition, in particular with regard to the percentages of amylose and of amylopectin. Amylose represents 15% to 35% of most starches. Amylopectin is the main constituent of most starches and the content thereof ranges from 65% to 100%. Indeed, certain starch varieties, termed “waxy”, consist essentially of amylopectin, from 95% to 100%.

For the purposes of the present invention, the expression “waxy starch” denotes all starch varieties containing an amylopectin content greater than or equal to 80%, preferably greater than or equal to 90% and even more preferably greater than or equal to 95%.

For the purposes of the present invention, said waxy starch is derived from one or more botanical varieties chosen from corn, rice, potato and wheat, and any mixtures thereof. The botanical varieties may be, according to the present invention, wild or hybrid and therefore may have undergone genetic modifications in order to modify their genome.

For the purposes of the present invention, the pregelatinized waxy starch is either a native starch having undergone no modification during its extraction or a “modified” starch, i.e. having undergone at least one treatment chosen from physical, chemical or enzymatic treatments, so as to modify its basic structure.

In the present invention, the terms “pregelatinized starch” and “precooked starch” are used without implied distinction to denote any starch having undergone a heat treatment in the presence of water, such that it loses virtually its entire granular structure and becomes soluble in cold water.

Said pregelatinized or precooked starch may undergo a heat treatment prior to its use in a process for producing confectioneries, or else undergo said heat treatment at the time of the process for producing confectioneries, by cooking the latter for example.

Thus, for the purposes of the invention, the term “pregelatinized starch” or “precooked starch” is intended to mean a state in which the starch is virtually no longer in a granular state, i.e. in a state in which it is no longer in the form of semi-crystalline granules characteristic of the state in which it is naturally present in the storage organs and tissues of higher plants, in particular in the seeds of cereals, the seeds of leguminous plants, the tubers of potato or of cassava, the roots, the bulbs, the stems and the fruits. This semi-crystalline state is essentially due to the macromolecules of amylopectin, one of the two main constituents of starch. In the native state, the starch grains have a degree of crystallinity which ranges from 15% to 45%, and which depends essentially on the botanical origin and on the possible treatment that it has undergone. Granular starch, placed under polarized light, exhibits, by microscopy, a characteristic black cross termed “Maltese cross”. This positive birefringence phenomenon is due to the semi-crystalline organization of these granules: the average orientation of the polymer chains is radial. For a more detailed description of granular starch, reference may be made to chapter II entitled “Structure et morphologie du grain d'amidon” [“Structure and Morphology of the Starch Grain”] by S. Perez, in the book “Initiation à la chimie et à la physico-chimie macromoléculaires” [“Introduction to macromolecular chemistry and physicochemistry”], first edition, 2000, volume 13, pages 41 to 86, Groupe Française d'Etudes et d'Applications des Polymères [French Group for Polymer Studies and Application].

The pregelatinized state of the starch is obtained by cooking granular starch, by incorporating water and by providing thermal and mechanical energy. The destructuring of the semi-crystalline granular state of the starch results in amorphous pregelatinized starches with disappearance of the Maltese cross produced under polarized light.

In the present invention, the pregelatinized starch preferably has a degree of crystallinity of less than 15%, preferably less than 5% and even more preferentially less than 1%, i.e. in an essentially amorphous state.

This degree of crystallinity can in particular be measured by X-ray diffraction, as described in patent U.S. Pat. No. 5,362,777 (column 9, lines 8 to 24).

According to one preferential embodiment of the present invention, the pregelatinized starch is advantageously substantially devoid of grains of starch having, by microscopy under polarized light, a Maltese cross, which is a sign indicating the presence of semi-crystalline granular starch.

The pregelatinized starches according to the present invention can be obtained by hydrothermal gelatinization treatment of native starches, in particular by steam cooking, cooking with a jet-cooker, cooking on a drum, cooking in blender/extruder systems or microwave systems followed by drying, for example in an oven, with hot air on a fluidized bed, on a rotating drum, by atomization, by extrusion or by lyophilization. Such starches generally have a solubility in demineralized water at 20° C. of greater than 5%, and more particularly between 10% and 100%, and a degree of starch crystallinity of less than 15%, generally less than 5%, and most commonly less than 1%, or even zero. By way of example, mention may be made of the products produced and sold by the applicant under the brand name PREGEFLO®.

According to one preferential embodiment of the invention, the starch used for preparing said pregelatinized starch is a native starch, and has therefore undergone no prior treatment or modification.

The use of such a starch makes it possible to obtain confectioneries having all the properties of the jelly confectioneries conventionally produced using gelatin. Indeed, said starch makes it possible, inter alia:
to obtain translucent molded subjects with well-defined outlines,
to provide a faithful rendition of the colors and flavors in the final product.

The organoleptic and physical characteristics of said starch go perfectly with the sweet and often slightly acid fragrances of the jelly candies,
to curb the recrystallization of the sugar by supersaturation, and as anti-crystallizing polymer by retaining a sufficient amount of water in the medium,
to avoid the cold flow phenomenon, which can prove to be dramatic,
to confer this elasticity and this particular consistency which makes chewing pleasant.

Indeed, and it is one of the particularities of the present invention, by virtue of the use of a pregelatinized waxy starch, it is possible to obtain confectioneries which have a chewability that is identical to or even greater than the jelly confectioneries conventionally containing gelatin. Usually, the final quality of the prior art confectioneries produced by partially or totally replacing gelatin with a different starch or with complex mixtures of hydrocolloids was always inferior and defects were very often observed: either the confectioneries were too hard, or they were too soft, or they were very tacky, or they disintegrated very rapidly, often too rapidly. Briefly, the texture obtained was not in line with consumer requirements.

The present invention makes it possible to overcome all these defects by providing a solution which ensures the production of jelly confectioneries wherein the texture meets consumer requirements perfectly. Said confectioneries have a perfect elastic texture, neither too hard nor too soft. Furthermore, the chewability time is increased and makes it possible to obtain confectioneries which do not disintegrate too quickly when they are consumed and which therefore allow the consumer to have an entirely satisfactory chewing time.

It is particularly surprising that a high-amylopectin pregelatinized waxy starch can be suitable for the partial or total replacement of gelatin in jelly confectioneries. This in fact goes against all the preconceptions expressed up until now for starches of this type, which were thus far described as having properties rather similar to gum arabic, whereas high-amylose starches are known to have properties similar to those of gelatin. To this effect, mention may be made of the document “The European Food and Drink Review—Autumn 1998, pp 57-60.”

It is therefore a question of real technical prowess on the part of the applicant company.

Thus, according to the present invention, the use of a pregelatinized waxy starch is in particular useful for the partial or total replacement of gelatin in jelly confectioneries of hard gum type (fruit gums, licorice gums, pastilles) and soft gum type (grouping together jellies and gums (jelly beans, wine gums)). Given that these confectioneries conventionally contain one or more thickening and/or gelling hydrocolloids of vegetable or animal origin, such as pectin, carrageenans, alginates, celluloses and starch, the present invention also covers the mixture of a pregelatinized waxy starch with one or more thickening and/or gelling hydrocolloids of vegetable or animal origin.

According to one embodiment of the present invention, said pregelatinized waxy starch is mixed with carrageenans.

According to one advantageous embodiment of the present invention, said jelly confectionery also comprises a vegetable fiber.

In the present invention, the term “vegetable fiber” denotes soluble and/or insoluble vegetable dietary fibers. The latter do not denote only fibrous materials in the strict sense, but also an entire series of different compounds which are contained almost exclusively in foods of vegetable origin and which have the common property of not being able to be broken down by human digestive enzymes. Almost all dietary fibers are carbohydrate polymers. For several years, nutritionists have been interested in a new type of dietary fibers: resistant starch. It is a starch or starch fraction which is not digested in the small intestine and which is fermented by the bacteria of the colon.

Unlike conventional vegetable fibers, these starches have the advantage of not modifying the appearance of the product into which they are incorporated and constitute as it were a source of fibers invisible to the naked eye. These starches are recommended in many applications. Thus, in the present invention, the vegetable fiber is chosen from soluble fibers and insoluble fibers, and any mixtures thereof.

According to a first advantageous embodiment of the invention, the vegetable fiber is an insoluble vegetable fiber, chosen from resistant starches. Natural resistant starches or resistant starches obtained by chemical and/or physical and/or enzymatic modification may be used without distinction.

According to the present invention, the term “resistant starch” denotes a starch or a starch fraction which is not digested in the small intestine and which is fermented by the bacteria of the colon. Four categories of resistant starch have been identified:
encapsulated starches, present in most unrefined vegetable foods such as dry vegetables, said starches being inaccessible to enzymes (RS1),
the granular starch of certain raw foods, such as banana or potato, and high-amylose starches (RS2),
retrograded starches, which are found in foods which have been cooked and then refrigerated or frozen (RS3),
chemically modified starches such as, in particular, etherified or esterified starches (RS4).

The resistant starches proposed, in particular, by the company National Starch, such as those sold under the name Hi-Maize®, are derived from high-amylose corn varieties and behave like insoluble fibers. RS3-type resistant starches are also proposed under the name Novelose®.

These resistant starches reduce the glycemic response, improve the health of the digestive system by virtue of their prebiotic properties and contribute to the regularity of transit, without having a high calorie content.

According to another advantageous embodiment of the present invention, the jelly confectionery comprises a mixture of a pregelatinized waxy starch and a soluble vegetable fiber.

According to this embodiment, the confectionery comprises from 0.1% to 75% of fiber, preferably from 2% to 10%, even more preferably 4% to 8%, the percentages being expressed by weight relative to the total weight of the confectionery.

In one advantageous embodiment of the present invention, the confectionery comprises from 50% to 75% of fiber, preferably from 56% to 62%. In this advantageous embodiment, the information “high fiber” or “source of fibers” may be affixed to the packaging of said confectionery. This represents an additional nutritional and marketing advantage. This is demonstrated hereinafter in example 4.

Preferably, said soluble vegetable fiber is chosen from the group made up of fructans, including fructooligosaccharides (FOSs) and inulin, glucooligosaccharides (GOSs), isomaltooligosaccharides (IMGs), transgalactooligosaccharides (TOSs), pyrodextrins, polydextrose, branched maltodextrins, indigestible dextrins and soluble oligosaccharides derived from oleaginous plants or protein-producing plants and any mixtures thereof.

The term “soluble fiber” is intended to mean fibers that are soluble in water. The fibers can be assayed according to various AOAC methods. By way of example, mention may be made of AOAC methods 997.08 and 999.03 for fructans, FOSs and inulin, AOAC method 2000.11 for polydextrose, AOAC method 2001.03 for assaying the fibers contained in branched maltodextrins and indigestible dextrins, or AOAC method 2001.02 for GOSs and also soluble oligosaccharides derived from oleaginous plants or protein-producing plants. Among the soluble oligosaccharides derived from oleaginous plants or protein-producing plants, mention may be made of soya, rapeseed or pea oligosaccharides.

According to one advantageous embodiment of the present invention, the jelly confectionery comprises a mixture of a pregelatinized waxy starch and soluble vegetable fibers which are branched maltodextrins.

The term “branched maltodextrins” (BMDs) is intended to mean specific maltodextrins identical to those described in patent EP 1 006 128-B1 of which the applicant is the proprietor. These BMDs have the advantage of representing a source of indigestible fibers beneficial to the metabolism and to the intestinal equilibrium.

According to the present invention, said branched maltodextrins are characterized in that they have:
between 15% and 50% of 1-6-glucosidic linkages, preferentially between 22% and 45%, more preferentially between 20% and 40%, and even more preferentially between 25% and 35%,
a reducing sugar content of less than 20%, preferentially between 2% and 20%, more preferentially between 2.5% and 15%, and even more preferentially between 3.5% and 10%,
a polydispersity index of less than 5, preferentially between 1 and 4, more preferentially between 1.5 and 3, and
a number-average molecular weight Mn of less than 4500 g/mol, preferentially between 400 and 4500 g/mol, more preferentially between 500 and 3000 g/mol, more preferentially between 700 and 2800 g/mol, even more preferentially between 1000 and 2600 g/mol.

In particular, use may be made of BMDs having between 15% and 35% of 1-6-glucosidic linkages, a reducing sugar content of less than 20%, a weight-average molecular weight Mw of between 4000 and 6000 g/mol and a number-average molecular weight Mn of between 250 and 4500 g/mol.

Certain subfamilies of BMDs described in the abovementioned application can also be used in accordance with the invention. They are, for example, high-molecular-weight BMDs having a reducing sugar content at most equal to 5 and an Mn of between 2000 and 4500 g/mol. Low-molecular-weight BMDs having a reducing sugar content of between 5% and 20% and a molecular weight Mn of less than 2000 g/mol may also be used.

In another advantageous embodiment of the present invention, use may also be made, in accordance with the invention, of the hypoglycemic hyper-branched maltodextrins described in application FR 1251810, of which the applicant is the proprietor.

In the present application, the pyrodextrins denote the products obtained by heating starch brought to a low moisture content, in the presence of acidic or basic catalysts, and which generally have a molecular weight of between 1000 and 6000 daltons. This dry roasting of the starch, most commonly in the presence of acid, leads to both depolymerization of the starch and rearrangement of the starch fragments obtained, resulting in highly branched molecules being obtained. This definition targets in particular the “indigestible” dextrins, having an average molecular weight of about 2000 daltons.

Polydextrose is a soluble fiber produced by thermal polymerization of dextrose, in the presence of sorbitol and of acid as catalyst. An example of such a product is, for example, Litesse® sold by Danisco.

According to one particularly advantageous embodiment of the present invention, the jelly confectionery comprises Nutriose®, which is an entire range of soluble fibers, recognized for their benefits, and produced and sold by the applicant. The products of the Nutriose® range are partially hydrolyzed wheat starch or corn starch derivatives which contain up to 85% fiber. This richness in fiber makes it possible to increase the digestive tolerance, to improve calorie control, to prolong energy release and to obtain a lower sugar content. In addition, the Nutriose® range is one of the most well-tolerated fibers available on the market. It shows higher digestive tolerance, allowing better incorporation than other fibers, thereby representing real dietary advantages.

There are many advantages to adding fibers, and more particularly branched maltodextrins such as Nutriose®, to the jelly confectionery of the present invention. In addition to the nutritive aspect and the provision of fibers that are very well-tolerated by the organism, the addition of these fibers also has a not insignificant technical value. Indeed, these fibers consist of long polymeric carbohydrate chains and therefore act as a texturing agent in the confectioneries. The presence of fibers therefore makes it possible to further increase the elasticity of the final product. Thus, the durability of the chewability is increased by the presence of these long chains which modify the texture of the product. Their branched nature considerably and advantageously decreases their tendency to retrograde, thereby making it possible to envisage their use in jelly confectioneries where the absence of retrogradation is necessary, in particular during prolonged storage.

What is more, it appears that said fibers have a not insignificant power regarding water retention within the confectionery. Thus, the presence of these fibers in the jelly confectionery according to the invention may make it possible to decrease the water activity in this confectionery and therefore to limit or to even totally prevent the cold flow phenomena observed during the production of chewing pastes or caramels for example.

The presence of branched maltodextrins makes it possible to prevent the cold flow phenomena encountered in jelly confectioneries produced by casting on a cooling table after cooking all the ingredients. In this type of production process, the cold flow phenomenon may be observed. This is the capacity of the chewing paste or of the caramel to deform without any force being applied. The confectionery will therefore have a tendency to run and to be crushed under the effect of its own weight. This is a fault that confectioners absolutely seek to prevent.

The presence of branched maltodextrins also makes it possible to increase the glass transition temperature of Tg or the amorphous part of said confectionery. This increase in the Tg makes it possible to stiffen the structure within the confectionery and consequently makes it possible to provide a good chewability staying power.

According to another advantageous embodiment of the present invention, the jelly confectionery comprises a mixture of a pregelatinized waxy starch and a water activity regulating agent or depressant chosen from sorbitol and glycerol, and any mixtures thereof.

According to this embodiment, the confectionery comprises from 0.1% to 15% of a water activity regulating agent or depressant, preferably from 1% to 8%, even more preferably 2% to 6%, the percentages being expressed by weight relative to the total weight of the confectionery.

According to one preferential embodiment, the water activity regulating agent or depressant is sorbitol.

According to one particularly advantageous embodiment of the present invention, the jelly confectionery comprises a mixture of a pregelatinized waxy starch, a soluble vegetable fiber and a water activity regulating agent or depressant.

According to an even more advantageous embodiment of the present invention, the jelly confectionery comprises a mixture of a pregelatinized waxy starch, branched maltodextrins and sorbitol.

According to another particularly advantageous embodiment, the present invention relates to a jelly confectionery characterized in that it comprises a mixture of:
0.1% to 25%, preferably of 2% to 10%, even more preferably 4% to 8%, of a pregelatinized waxy starch, and of
0.1% to 75% of fiber, preferably of 2% to 10%, even more preferably 4% to 8%, of branched maltodextrins, and of
0.1% to 15% of a water activity regulating agent or depressant, preferably of 1% to 8% of sorbitol.

Sorbitol is a very well-known polyol obtained by hydrogenation of the glucose. It is characterized by its technological and nutritional properties. It has a stabilizing and humectant capacity, making it possible to lower the water activity of the final products.

The water activity or aw represents the amount of free water available within a food for any subsequent biochemical reactions. It does not represent the water content (or moisture content), but indeed the availability of this water. Furthermore, it directly determines the physical, mechanical, chemical and microbiological properties of numerous substances, such as, inter alia, the fluidity, coagulation, cohesion and static electricity. The storage capacity of foods, the color stability, the taste stability, the vitamin content, the flavor and the conditions favorable to mold formation and to microbe growth are directly influenced by the aw value.

Thus, adding sorbitol makes it possible to reduce the aw in the jelly confectioneries of the present invention, and therefore makes it possible to preserve the elastic texture and the chewability of said confectioneries by stabilizing the water that they contain.

Indeed, the confectioneries of the present invention have the particularity of having an aw that is lower than the aw conventionally measured in jelly confectioneries usually containing gelatin.

According to the present invention, the aw of the jelly confectioneries is less than 0.8. According to one preferred embodiment, the water activity of the jelly confectioneries according to the invention is less than 0.7.

The water activity measurement is a parameter defined and validated by USP 1112 (United States Pharmacopeia).

In the food-processing industry, the water activity (aw) value denotes a humidity equilibrium defined by the partial pressure of the water vapor at the surface of the product. This activity depends on the composition, on the temperature and on the amount of water present in the product. The water activity gives information on the physical, mechanical, chemical and microbiological stability of a product; it influences the growth rate of unwanted organisms such as bacteria or fungi, which produce “toxins” or other harmful substances. It also influences other chemical/biochemical reactions (for example the Maillard reaction) which occur according to the available amount of free water.

Fundamentally, the following characteristics of a food product are dependent on the aw:
the biological characteristics of the product, that is to say its biological stability, i.e. the microorganism growth,
the percentage of proteins and vitamins
characteristics such as color, odor, taste and nutritive value,
the chemical stability of the composition,
the reaction to the ambient humidity and the temperature,
the solubility or the texture,
the durability, i.e. the preservation over time.

In order to determine the water activity (aw value), it is necessary to use laboratory instruments that are specific for measuring the humidity of the air, directly above a sample in a closed measuring chamber after having obtained the humidity equilibrium (Equilibrium). The humidity of the air is proportional to the aw value. A reliable and relevant measurement is possible provided that the samples have a constant temperature and that the humidity equilibrium is definitive. The measurement of the water activity requires a certain amount of time, which depends on the physiochemical properties of the samples, and this time cannot be shortened.

There are 3 methods for measuring the humidity of the air above the sample. However, resistive-electrolytic technology is the most widely indicated from the viewpoint of its precision, its reproducibility and its maintenance.

An apparatus of Novasina LabMaster type, sold by the company Novasina AG, Lachen, Switzerland, can for example be used.

The test sample is placed in a completely hermetic measuring chamber at a Peltier-stabilized temperature. During the measurement, the sample humidifies or dehumidifies the volume of air inside the chamber. This characterizes the free water.

This exchange takes place until the partial pressure saturation is equal to zero. A unit for very accurate measurement of humidity and temperature determines the humidity conditions in the measuring chamber. If these parameters remain stable over a period adjustable by the user, the software of the apparatus determines the aw value.

Another particularly advantageous property of the present invention is that the various constituents used (namely the pregelatinized waxy starch, the branched maltodextrins and the sorbitol) do not need to be hydrated before they are incorporated, unlike gelatin. They are therefore simple to use. Moreover, this gelatin hydration step was a critical step of the process for producing confectioneries since it comprises a considerable risk of introducing bacteria into the preparations. Indeed, gelatin is an excellent support for bacterial development.

The confectioneries according to the present invention are therefore found to also be more hygienic since they have a lower bacterial load.

The jelly confectionery according to the present invention also comprises from 0% to 8% of gelatin, expressed by total weight of the confectionery, depending on whether it is desired to replace all or part of said gelatin.

According to one preferred embodiment of the present invention, the jelly confectionery does not contain gelatin and the replacement is therefore total replacement.

The confectionery according to the present invention is a confectionery with or without sugar.

According to one preferred embodiment, it is a gelatin-free confectionery.

According to one preferred embodiment of the invention, it is a sugar-free and gelatin-free confectionery.

According to the present invention, when the confectioneries are made with sugar (sucrose) and glucose syrup, the applicant has noted that it is particularly important to adhere to a very precise ratio between these two constituents, so as to give the confectionery excellent elasticity but also very good plasticity. Indeed, glucose syrup, resulting from the hydrolysis of starch, is known to prevent the crystallization of sugar and, consequently, the glucose syrup content is a key factor in confectioneries, and more particularly in confectioneries of jelly type.

Thus, in the present invention, the sugar/glucose syrup ratio is between 20/80 and 60/40.

According to one preferred embodiment of the invention, the sugar/glucose syrup ratio is between 25/75 and 50/50.

In the present invention, the term “hydrolysis of starch” is intended to mean any process of acid or enzymatic hydrolysis of starch from leguminous plants, from cereals or from tuberous plants. Various hydrolysis processes are known and have been described generally on pages 511 and 512 of the book Encyclopedia of Chemical Technology by Kirk-Othmer, 3^{rd} edition, vol. 22, 1978. These hydrolysis products are also defined as purified and concentrated mixtures formed from linear chains consisting of D-glucose units and of D-glucose polymers which are essentially α(1→4)—linked with only from 4% to 5% of α(1→6) branched glucosidic linkages, of extremely varied molecular weights, which are completely soluble in water. Starch-hydrolyzates are very well known and perfectly described in the Encyclopedia of Chemical Technology by Kirk-Othmer, 3^{rd} edition, vol. 22, 1978, pp. 499 to 521.

In the present application, the glucose syrups are the products of hydrolysis of starch having a DE (Dextrose Equivalent) greater than 20. Conventionally, the distinction between starch hydrolysis products is based mainly on the measurement of their reducing power, conventionally expressed by the notion of Dextrose Equivalent or DE. The DE corresponds to the amount of reducing sugars, expressed in dextrose equivalent for 100 g of solids of the product. The DE therefore measures the strength of the starch hydrolysis, since the more the product is hydrolyzed, the more small molecules it contains (such as dextrose and maltose, for example) and the higher its DE. Conversely, the more large molecules the product contains (polysaccharides), the lower its DE.

Such products are perfectly known to those skilled in the art and are, for example, the glucose syrups sold by the applicant under the name “Roquette sirops de glucose” [Roquette glucose syrups”], and for example the syrup Roquette sirop de glucose 4779 [Roquette glucose syrup 4779], meaning that it has a DE of 47 and a solids content of 79%.

From a regulatory point of view and also for the purposes of the present invention, glucose syrups have a solids content at least equivalent to 70%.

According to the present invention, the jelly confectioneries can also comprise gum arabic. Gum arabic is a complex and variable mixture of oligosaccharides, polysaccharides and glycoproteins of arabinogalactan. Depending on the source, the glycan constituents contain a greater proportion of L-arabinose relative to D-galactose (Acacia seyal) or of D-galactose relative to L-arabinose (Acacia senegal). The gum of Acacia seyal also contains significantly more 4-O-methyl-D-glucuronic acid but less L-rhamnose and unsubstituted D-glucuronic acid than Acacia senegal.

Its role in confectionery is to adjust the texture and bring more or less elasticity to the confectionery in which it is used. It makes it possible, for example, to extend the chewability of the confectionery in which it is used, i.e. the time required to chew the confectionery until it has completely disintegrated.

Although its use has advantages, it is not obligatory in the present invention.

The jelly confectionery according to the present invention therefore also comprises from 0% to 8% of gum arabic, expressed by total weight of the confectionery.

According to one embodiment of the invention, the jelly confectionery is a confectionery with or without sugar, without gelatin and without gum arabic.

The jelly confectioneries according to the invention may also contain one or more sweeteners. Various sweeteners may be used, such as sugars or polyols, in powder or syrup form. The sugars are chosen from the group made up of monosaccharides, disaccharides, trisaccharides, oligosaccharides and polysaccharides, such as, for example, glucose syrups, glucose-fructose syrups, fructose-glucose syrups, high-maltose glucose syrups, sucrose, fructose, maltose, trehalose, mannose, dextrose, tagatose or isomaltulose, alone or as a mixture with one another. The polyols are preferentially chosen from the group made up of maltitol, mannitol, erythritol, xylitol, iditol, maltitol syrups, isomalt, lactitol, and hydrogenated glucose syrups, alone or as a mixture with one another.

Use may also be made of strong sweeteners of any type, such as, for example, saccharine, aspartame, or acesulfame K, used alone or as synergistic mixtures. Advantageously, sorbitol is not used as sweetener in the confectionery according to the invention.

In one particular embodiment, the sweetener is chosen from saccharine, aspartame, acesulfame K, mannitol, xylitol, maltitol, mannitol, erythritol, xylitol, iditol, isomalt and lactitol.

According to the invention, the sweetener preferably represents 25% to 85%, preferably 40% to 85% and more preferentially from 60% to 85% by total weight of the confectionary.

The jelly confectioneries according to the invention may also comprise one or more compounds chosen from non-reducing sugars, fats, emulsifiers, preservatives, overrun agents, firming agents, gelling agents, humectants, acidifying agents, natural or synthetic flavors, taste enhancers, vitamins, pharmaceutical active agents, minerals such as calcium or magnesium and other food supplements such as, for example, DHA, natural or synthetic dyes, salts, acids, or various elements intended either to improve the quality, or to flavor the composition, such as dry fruits, candied fruits, fruits which have been dried or otherwise transformed (pressed, concentrated, in powder form), and also fruit purees and fruit pulps, which are generally present in said confectionery in an amount of 0% to 30% by weight relative to the total weight of the confectionery.

In addition, a subject of the present invention is a process for preparing jelly confectioneries, characterized in that it comprises the steps of:
preparing a mixture comprising from 0.1% to 25%, preferably from 2% to 10%, even more preferably from 4% to 8%, of a pregelatinized waxy starch, from 0.1% to 75% of vegetable fiber and from 0.1% to 15% of an aw regulating agent or depressant, at least one sweetener, preferably other than sorbitol, and water,
cooking the mixture at a temperature of between 100° C. and 150° C. until the desired solids content is obtained,
shaping the cooked mixture so as to obtain confectioneries of jelly type,
recovering the jellied confectioneries thus obtained.

According to the invention, it is absolutely possible to envisage cooking the starch separately and then adding the other ingredients thereto, or preheating the sweetener before adding the starch thereto, but, for a continuous production, it is preferred to disperse the sweeteners, the starch, the fibers and the aw reducing agent or depressant in a mixing tank, to preheat this mixture to approximately 70-80° C. in order to dissolve the sweeteners, to cook the mixture on a high-pressure cooker at a temperature of between 100 and 150° C. depending on the desired texture and the type of confectionery prepared, and then to add the fat, the emulsifier, the overrun agent(s), the flavors, the dyes, the active ingredients and the strong sweeteners. The cooking temperature must be sufficient to cook the starch (above 120° C.), except when it is chosen to cook the starch apart, since, in this case, the sweetener can be cooked alone at approximately 110° C. before incorporation of the starch that has been cooked apart. In any event, the temperature for cooking the mixture is less than or equal to 150° C., which constituents one of the advantages of the present invention. The cooking time depends on the equipment used.

The cooking can be carried out on jacketed cookers at atmospheric pressure, under partial or total vacuum or under pressure, or continuously on high-pressure cookers such as tubular exchangers, plate exchangers or jet-cookers. The jet-cooker may comprise one or more steam injectors, thereby modifying the cooking times. Injection of live steam into the product provides rapid and homogeneous dispersion of the heat and of the ingredients. The tubular exchanger requires a homogeneous dispersion of all the ingredients before cooking, the cooking times are longer and the intensity less strong.

After cooking, the fat, the emulsifier, the overrun agent(s) and the flavors, dyes, acids and others are added to the hot syrup at a temperature of between 60 and 90° C., the mixture is then cast on a cooling plate, and pulling is carried out for approximately one minute at 50-60 movements. Once the pulling has been carried out, the shaping and the wrapping of the confectioneries obtained are carried out.

The invention will be understood more clearly on reading the examples which follow, which are intended to be illustrative, making reference only to certain embodiments and certain advantageous properties according to the invention, and nonlimiting.

### EXAMPLE 1

### Chewing Pastes Containing Sugar According to the Invention

The objective is to produce jelly confectioneries of chewing paste type containing sugar according to the present invention but no longer containing gelatin.

In this example, chewing pastes were produced by incorporating in each new test one of the three constituents so as to achieve, in test 5, the preferred embodiment consisting in using a mixture of pregelatinized waxy starch, soluble fibers and an aw-regulating agent.

The control is a conventional recipe for chewing paste containing sugar and containing gelatin. None of the tests contain gelatin. The replacement was therefore total.

Test 1 concerns chewing pastes containing only pregelatinized waxy starch.

Test 2 concerns chewing pastes containing pregelatinized waxy starch and soluble fibers.

Test 3 concerns chewing pastes containing pregelatinized waxy starch and an aw-regulating agent.

Test 4 concerns chewing pastes containing neither pregelatinized waxy starch nor gelatin, but containing soluble fibers and an aw-regulating agent.

Test 5 concerns chewing pastes containing pregelatinized waxy starch, soluble fibers and an aw-regulating agent.

A—Formulae

The formulae used for the control and for the five tests are presented in table 1 below.

Instant Gum AA gum arabic is a purified and granulated, instantaneously soluble gum obtained from Acacia and sold by the company Nexira, Rouen, France.

It is used as emulsifier and stabilizer since it is suitable for oil-in-water emulsions.

Biscuitine™ 621 is a non-lauric, refined, hydrogenated vegetable fat which has a melting point of 35° C. and is sold by the company Loders Croklaan B.V., Wormerveer, The Netherlands.

The HLB5 sucrose esters are esters of sucrose and of fatty acids obtained by transesterification of methylesters and of sucrose, used as non-ionic emulsifiers of fats, and sold by the company Stéarineries Dubois in Boulogne, France.

The apple flavor is sold by the company Symrise AG, Clichy-la-Garenne, France.

B—Method
Pour cold drinking water into a tank.
Introduce the gum arabic, the pregelatinized waxy starch and the soluble fibers, with vigorous stirring.
After dispersion and verification of the absence of lumps, introduce the glucose syrup, still with stirring.
Then add the aw-regulating agent.
Then end with the addition of the sucrose.
Cook the preceding mixture at a predetermined temperature and at atmospheric pressure so as to obtain a mixture containing 90-94% solids. Generally, the cooking temperature is between 105 and 120° C. It is also possible to cook the preceding mixture under vacuum at a pressure of −0.5 b. Mix well during the cooking step in order to prevent the mixture from burning.
After the cooking step, introduce the fat (biscuitine) which has been melted at 50-60° C. or which has not been melted, with the emulsifier (of the HLB5 sucrose ester type). Mix well.
Once the mass has cooled below 80° C., add the citric acid, then the flavor.
For the control containing the gelatin, add the molten gelatin in solution at 60° C. after the cooking of the preceding mixture and cooling of the latter to a temperature of approximately 80° C.
Cast the chewing paste onto a cooling table until it is at a temperature of between 50 and 60° C.
Draw the chewing paste for 1 minute (50 to 60 movements) so as to obtain good aeration. The aeration can also be obtained in a whipping machine under pressure (1 to 2 bar) in a continuous production process.
Leave the aerated chewing paste to stand in order for it to cool (between 45° C. and 55° C.) and in order for it to recover texture.

Shape, cut and wrap the confectioneries.

C—Tests

For these various tests, the water activity was measured according to the method described above and particularly well known to those skilled in the art, and the chewing pastes were tasted by a trained jury of 10 individuals who graded the texture in the mouth according to three parameters: tacky nature, hardness, elasticity.

In certain cases, the chewing time, i.e. the time measured between the introduction of the chewing paste into the buccal cavity and its total disintegration under “normal” chewing, was also determined using a timer.

D—Analysis

The five tests all produced confectioneries which have an aw below the aw of the control with gelatin.

The control confectioneries have a good elastic texture. Their elasticity and their chewability are in accordance with taster expectations regarding this type of confectionery and their chewability time was 1 minute 35 seconds.

The confectioneries of test 4 not containing pregelatinized waxy starch have a tacky and not very elastic texture. In addition, when the mixture was cast onto the cooling table, a cold flow phenomenon was observed. That is to say the chewing paste deforms without any force being applied on top. As a result, the confectioneries of the test have a tendency to “run” and to become crushed. This is a fault that confectioners seek to avoid.

This clearly demonstrates that the pregelatinized waxy starch is absolutely necessary in order to make it possible to obtain confectioneries with good staying power and a good texture.

The confectioneries of tests 1, 2, 3 and 5 have, for their part, elastic textures which are entirely satisfactory with respect to consumer expectations. The best of the textures is obtained for the confectioneries containing the mixture of the three constituents, i.e. the pregelatinized waxy starch, the fibers and the water activity-regulating agent.

For these 4 tests, the chewability times were also timed and were longer than those obtained for the control confectionery. In each test, the chewability time is longer than two minutes and, for test 5, the time required to taste and swallow the chewing paste is longer than 3 minutes.

For all the confectioneries not containing gelatin, an excellent persistence of elasticity is observed. This means that said confectioneries have excellent staying power in the mouth and that the elastic aspect is maintained during chewing.

This perfectly demonstrates that the use of a gelatinized waxy starch for partially or totally replacing gelatin makes it possible to obtain confectioneries which have a very good elastic texture, but also to extend the chewability time thereof.

This is particularly advantageous and could allow the development of a new confectionery with an extended chewability time which could lie, in marketing terms, between conventional chewing paste and chewing gum which no longer always has a good press because of the origins of the compounds of the gum and also the non-biodegradable residues remaining at the end of the consumption of said chewing gum.

### EXAMPLE 2

### Chewing Pastes Containing Sugar According to the Invention

The objective of this new example is also to produce jelly confectioneries of chewing paste type containing sugar according to the present invention but no longer containing gelatin.

The control is a conventional recipe for chewing paste containing sugar and containing gelatin.

Test 1 is a recipe for chewing paste according to the present invention comprising pregelatinized waxy starch, soluble fibers and a water activity regulating agent.

Test 2 is also a test according to the present invention with glucose syrup and sucrose contents which are different than test 1.

A—Formulae

The formulae used for the control and for the two tests are presented in table 2 below.

B—Method

The method for preparing the confectioneries according to example 2 is the one described previously for example 1.

C—Analysis

The control confectioneries have a good elastic texture. Their elasticity and their chewability are in accordance with taster expectations regarding this type of confectionery.

The two tests describing gelatin-free confectioneries which contain pregelatinized waxy starch, fibers and an aw-reducing agent have a very good elastic texture superior to that of the control containing gelatin. Once again, an excellent persistence of elasticity is observed during the consumption of the gelatin-free confectioneries.

The advantage of the invention is again demonstrated in this example.

### EXAMPLE 3

### Sugar-Free Chewing Pastes According to the Invention

The objective is to produce sugar-free jelly confectioneries of chewing paste type which no longer contain gelatin, according to the present invention. Each time, the chewing pastes produced contain only pregelatinized waxy starch. The optional addition of fibers and/or of an aw-regulating agent is not represented in this example.

The control is a conventional recipe for chewing paste containing gelatin and gum arabic.

Test 1 concerns confectioneries no longer containing gelatin, which has been replaced with pregelatinized waxy starch and with gum arabic.

Test 2 concerns confectioneries no longer containing gelatin, which has been replaced with pregelatinized waxy starch only.

A—Formulae

The formulae used for the control and for the two tests are presented in table 3 below.

B—Method

The method for preparing the confectioneries according to example 3 is the one described previously for example 1, the only difference being that the cooking temperature is higher and is, for the three tests, around 130° C.

C—Analysis

The control confectioneries have a good elastic texture. Their elasticity and their chewability are in accordance with taster expectations regarding this type of confectionery.

The two tests describing sugar-free, gelatin-free confectioneries which contain pregelatinized waxy starch and, in one case, also gum arabic, have a very good elastic texture superior to that of the control containing gelatin. Once again, the chewability times were extended.

This perfectly demonstrates that the use of a pregelatinized waxy starch for partially or totally replacing gelatin makes it possible to obtain sugar-free confectioneries which have a very good elastic texture, but also to extend the chewability time thereof. Persistence of elasticity is also observed for these confectioneries produced without sugar and without gelatin.

The presence or absence of gum arabic has no significant effect on the final qualities of the confectionery.

This also demonstrates that the use of a pregelatinized waxy starch would make it possible to be able to partially or totally replace the gelatin, but also the gum arabic that can sometimes remain in confectioneries.

There is therefore a double advantage.

### EXAMPLE 4

### Chewing Pastes Without Added Sugar and High in Fibers According to the Invention

The objective of this new example is to produce jelly confectioneries of chewing paste type which do not contain added sugar and are enriched with fibers which contain pregelatinized waxy starch as a total replacement for the gelatin initially contained in the confectioneries.

The control is a recipe for chewing paste without added sugar, enriched with fibers and containing gelatin.

A—Formulae

The formulae used for the control and for the test are presented in table 4 below.

B—Method
Introduce and disperse the Nutriose® FB06, the mannitol 60, the Pregeflo C100 waxy starch, the citric acid and the acesulfame K in water. This constituents part A.
Cook the preceding mixture at a cooking temperature of 110° C. It is important to heat gently in order to reach 110° C. (with a vapor pressure of a maximum of 2.5) while constantly stirring in order to prevent the mixture from burning.
Mix the fat (biscuitine) melted at 50-60° C., with the glycerol and emulsifier (of the HLB5 sucrose ester type). This is part B.
Add part B to part A as soon as the cooking has finished.
Mix the whole mixture in a mixer until complete homogenization is obtained.
Once the mass has cooled below 80° C., add the gelatin solution (for the control) and the flavors.
Cast the chewing paste onto a cooling table and carry out the pulling thereof for one minute (60 movements).
Leave the aerated chewing paste to stand in order for it to cool (between 45° C. and 55° C.) and in order for it to recover texture.
Shape, cut and wrap the confectioneries thus obtained.

C—Analysis

In terms of the composition, the confectioneries obtained are sugar-free and are therefore potentially good for the teeth since they do not cause cavities.

Furthermore, they contain more than 45 g per 100 g of confectioneries of fibers and can therefore be sold with the label “high fiber” (or “excellent source of fibers”).

In terms of the texture, the jury of 10 individuals judged the confectioneries of test 1 to be identical to those of the control in terms of texture and chewability. This therefore demonstrates that gelatin can be completely replaced with pregelatinized waxy starch according to the present invention and without having a negative impact on the final texture of the confectionery.

A very good persistence of elasticity is also observed in this example.

TABLE 1
Composition of chewing pastes containing sugar according to the invention (example 1)

| | | | Test 1: Pregelatinized | | | | Test 3: Starch + aw- | |
|---|---|---|---|---|---|---|---|---|
| | Control with gelatin | | waxy starch alone | | Test 2: Starch + fibers | | regulating agent | |
| | | Final | | Final | | Final | | Final |
| | | composition | | composition | | composition | | composition |
| INGREDIENTS | Used | (%) | Used | (%) | Used | (%) | Used | (%) |
| Gelatin 100 bl at 40% | 38 | 3.9 | 0 | 0 | 0 | 0 | 0 | 0 |
| C4280s glucose syrup | 432 | 42.5 | 504 | 49.1 | 511 | 47.4 | 535 | 49.6 |
| Sucrose | 336 | 34.8 | 259 | 27 | 192 | 22.2 | 200 | 23.2 |
| Instantgum AA gum | 23 | 2.7 | 23 | 2.7 | 23 | 2.7 | 23 | 2.7 |
| arabic | | | | | | | | |
| Pregeflo C100 ® | 0 | 0 | 45 | 5.1 | 45 | 4.7 | 45 | 4.7 |
| pregelatinized waxy | | | | | | | | |
| starch | | | | | | | | |
| Nutriose ® FB06 | 0 | 0 | 0 | 0 | 60 | 6.8 | 0 | 0 |
| soluble fiber | | | | | | | | |
| Aw regulator: | 0 | 0 | 0 | 0 | 0 | 0 | 44 | 3.6 |
| Néoorb ® 70/70 | | | | | | | | |
| Dissolution water | 129 | 0 | 127 | | 127 | | 111 | |
| Biscuitine ™ 621 | 32 | 3.7 | 32 | 3.7 | 32 | 3.7 | 32 | 3.7 |
| HLB5 sucrose ester | 1 | 0.1 | 1 | 0.1 | 1 | 0.1 | 1 | 0.1 |
| Anhydrous citric acid | 5 | 0.6 | 5 | 0.6 | 5 | 0.6 | 5 | 0.6 |
| Apple flavor | 4 | 0.4 | 4 | 0.4 | 4 | 0.5 | 4 | 0.5 |
| Residual water | | 11.3 | | 11.3 | | 11.3 | | 11.3 |
| Total | 1000 | | 1000 | 100 | 1000 | 100 | 1000 | 100 |
| Cooking temperature | 118° C. | | 118° C. | | 105° C. | | 108 | |
| Observations | Good very | | Good | | Good | | Good | |
| | elastic | | elastic | | elastic | | elastic | |
| | texture | | texture | | texture | | texture | |
| | aw: 0.71 | | aw: 0.52 | | aw: 0.56 | | aw: 0.54 | |

| | Test 4: | | Test 5: starch + fibers + | |
|---|---|---|---|---|
| | fibers + aw-regulating agent | | aw-regulating agent | |
| INGREDIENTS | Used | Final composition (%) | Used | Final composition (%) |
| Gelatin 100 bl at 40% | 0 | 0 | 0 | 0 |
| C4280s glucose syrup | 520 | 48.2 | 485 | 45 |
| Sucrose | 195 | 22.6 | 182 | 21.1 |
| Instantgum AA gum arabic | 23 | 2.7 | 23 | 2.7 |
| Pregeflo C100 ® pregelatinized | 0 | 0 | 45 | 4.7 |
| waxy starch | | | | |
| Nutriose ® FB06 soluble fiber | 60 | 6.7 | 60 | 6.8 |
| Aw regulator: Nósorb ® 70/70 | 44 | 3.6 | 44 | 3.6 |
| Dissolution water | 116 | | 119 | |
| Biscuitine ™ 621 | 32 | 3.7 | 32 | 3.7 |
| HLB5 sucrose ester | 1 | 0.1 | 1 | 0.1 |
| Anhydrous citric acid | 5 | 0.6 | 5 | 0.6 |
| Apple flavor | 4 | 0.5 | 4 | 0.5 |
| Residual water | | 11.3 | | 11.2 |
| Total | 1000 | 100 | 1000 | 100 |
| Cooking temperature | 113° C. | | 118° C. | |
| Observations | Tacky texture not very elastic | | Very good very | |
| | Cold flow Aw: 0.55 | | elastic texture | |
| | | | Aw: 0.55 | |

TABLE 2
Composition of chewing pastes containing sugar according to the invention (example 2)

| | Control | | Test 1 | | Test 2 | |
|---|---|---|---|---|---|---|
| | | Final | | Final | | Final |
| | | composition | | composition | | composition |
| INGREDIENTS | Used | (%) | Used | (%) | Used | (%) |
| Gelatin 100 bl at 40% | 38 | 3.8 | 0 | 0 | 0 | 0 |
| C4280s glucose syrup | 372 | 41.3 | 300 | 26.8 | 485 | 45 |
| Sucrose | 336 | 36.8 | 367 | 40.9 | 182 | 21 |
| Instantgum AA gum arabic | 23 | 2.7 | 23 | 2.5 | 23 | 2.7 |
| Pregeflo C100 ® pregelatinized | 0 | 0 | 45 | 4.5 | 45 | 4.7 |
| waxy starch | | | | | | |
| Nutriose ® FB06 soluble fiber | 0 | 0 | 60 | 6.5 | 60 | 6.8 |
| Aw regulator: Néosorb ® 70/70 | 0 | 0 | 44 | 3.4 | 44 | 3.6 |
| Dissolution water | 189 | 0 | 119 | 0 | 119 | 0 |
| Biscuitine ™ 621 | 32 | 3.7 | 32 | 3.6 | 32 | 3.7 |
| HLB5 sucrose ester | 1 | 0.1 | 1 | 0.1 | 1 | 0.1 |
| Anhydrous citric acid | 5 | 0.6 | 5 | 0.6 | 5 | 0.6 |
| Apple flavor | 4 | 0.4 | 4 | 0.4 | 4 | 0.5 |
| Residual water | | 10.6 | | 10.7 | | 11.3 |
| Total | 1000 | | 1000 | 100 | 1000 | 100 |
| Cooking temperature | 110° C. | | 110° C. | | 110° C. | |
| Observations | Good very | | Good very | | Good very | |
| | elastic texture | | elastic texture | | elastic texture | |
| | Aw: 0.71 | | Aw: 0.52 | | Aw: 0.65 | |

TABLE 3
Composition of sugar-free chewing pastes according to the invention (example 3)

| | | | Test 1: Pregelatinized waxy | | Test 2: Pregelatinized waxy | |
|---|---|---|---|---|---|---|
| | Control | | starch and gum arabic | | starch alone | |
| | | Final | | Final | | Final |
| | | composition | | composition | | composition |
| INGREDIENTS | Used | (%) | Used | (%) | Used | (%) |
| Gelatin 100 bl at 40% | 20.2 | 1.1 | 0 | 0 | 0 | 0 |
| Lycasin ® maltitol syrup | 569.8 | 57.4 | 579.8 | 55.3 | 610.8 | 55.8 |
| HBC or 8055 (73-75% MS) | | | | | | |
| Mannitol 60 | 137.6 | 18.4 | 110.6 | 14.5 | 137.6 | 19.6 |
| Xylitol 300 | 30.6 | 4.1 | 30.6 | 4 | 30.6 | 4.4 |
| Pregeflo C100 ® pregelatinized | 0 | 0 | 45 | 5.9 | 45 | 4.7 |
| waxy starch | | | | | | |
| Dissolution water | 139.4 | | 131.6 | | 128.6 | |
| Instantgum AA gum arabic | 55 | 3.6 | 55 | 3.6 | 0 | 0 |
| Biscuitine ™ 621 | 42 | 5.6 | 42 | 5.5 | 42 | 6 |
| HLB5 sucrose ester | 1 | 0.1 | 1 | 0.1 | 1 | 0.1 |
| Anhydrous citric acid | 4.4 | 0.6 | 4.4 | 0.6 | 4.4 | 0.6 |
| Flavour and dye | qs | | qs | | qs | |
| Residual water | | 9.1 | | 10.4 | | 8.8 |
| Total | 1000 | 100 | 1000 | 100 | 1000 | 100 |
| Cooking temperature | 130° C. | | 131° C. | | 131° C. | |
| Observations | Good elastic | | Very good | | Good very | |
| | texture | | elastic texture | | elastic texture | |

TABLE 4
Composition of chewing pastes without added sugar and enriched with
fibers according to the invention (example 4)

| | | Control | | | Test 1 | |
|---|---|---|---|---|---|---|
| | | | | Final composition | | Final composition |
| | INGREDIENTS | Used (g) | | (%) | Used (g) | (%) |
| Part A | Nutriose ® FB06 soluble fiber | 503 | | 57.6 | 503 | 56.60 |
| | Mannitol 60 (powder) | 80 | | 9.5 | 80 | 9.3 |
| | Pregeflo C100 ® pregelatinized | 0 | | 0 | 25 | 2.80 |
| | waxy starch | | | | | |
| | Acesulfame K | 0.8 | | 0.1 | 0.8 | 0.1 |
| | Anhydrous citric acid | 6 | | 0.7 | 6 | 0.7 |
| | Dissolution water | 238.5 | | — | 238.5 | — |
| Part B | Biscuitine ™ 621 | 74.2 | | 8.8 | 74.2 | 8.6 |
| | Glycerol | 50 | | 5.9 | 50 | 5.8 |
| | HLB5 sucrose ester | 1 | | 0.1 | 1 | 0.1 |
| | Gelatin 100 bl at 40% | 25 | | 1.2 | 0 | 0 |
| | Blackberry flavor | 4 | | 0.5 | 4 | 0.5 |
| | Blackcurrant flavor | 15 | | 1.8 | 15 | 1.7 |
| | Tutti-frutti flavor | 2.5 | | 0.3 | 2.5 | 0.3 |
| | Residual water | | | 13.5 | | 13.5 |
| | Total | 1000 | g | 100 | 1000 | 100 |

| | | |
|---|---|---|
| Cooking temperature | 110° C. | 110° C. |
| Aw | 0.6 | 0.6 |

1-16. (canceled)

17. A jelly confectionery comprising from 0.1% to 25% of pregelatinized waxy starch, the percentage being expressed by weight relative to the total weight of the confectionery.

18. The confectionery as claimed in claim 17, characterized in that the sugar/glucose syrup ratio is between 20/80 and 60/40.

19. The confectionery as claimed in claim 17, characterized in that it is gelatin-free.

20. The confectionery as claimed in claim 17, characterized in that it is sugar-free.

21. The confectionery as claimed in claim 17, characterized in that it also comprises a vegetable fiber.

22. The confectionery as claimed in claim 21, characterized in that it comprises from 0.1% to 75% of fiber, the percentages being expressed by weight relative to the total weight of the confectionery.

23. The confectionery as claimed in claim 21, characterized in that it comprises from 50% to 75% of fiber, the percentages being expressed by weight relative to the total weight of the confectionery.

24. The confectionery as claimed in claim 21, characterized in that the vegetable fiber is chosen from soluble fibers and insoluble fibers and mixtures thereof.

25. The confectionery as claimed in claim 24, characterized in that the soluble vegetable fiber is a fructan, glucooligosaccharides (GOSs), isomaltooligosaccharides (IMOs), transgalactooligosaccharides (TOSs), pyrodextrins, polydextrose, branched maltodextrins, indigestible dextrins or soluble oligosaccharides derived from oleaginous plants or protein-producing plants or any mixtures thereof; and/or said insoluble vegetable fiber is selected from the group consisting of resistant starches, cereal fibers, fruit fibers, vegetable fibers, leguminous plant fibers and mixtures thereof.

26. The confectionery as claimed in claim 17, characterized in that it comprises a water activity regulating agent or depressant chosen from sorbitol and glycerol and any mixtures thereof.

27. The confectionery as claimed in claim 26, characterized in that it comprises from 0.1% to 15% of a water activity regulating agent or depressant, the percentages being expressed by weight relative to the total weight of the confectionery.

28. The confectionery as claimed in claim 17, characterized in that it comprises a mixture of a pregelatinized waxy starch, a soluble fiber and a water activity regulating agent or depressant.

29. The confectionery as claimed in claim 28, characterized in that it comprises a mixture of:
0.1% to 25% of a pregelatinized waxy starch,
0.1% to 75% of fiber of branched maltodextrins, and
0.1% to 15% of a water activity regulating agent or depressant.

30. The confectionery as claimed in claim 28, characterized in that the water activity regulating agent or depressant is chosen from sorbitol and glycerol and any mixtures thereof.

31. A process for preparing jelly confectioneries, characterized in that it comprises the steps of:
preparing a mixture comprising from 0.1% to 25% of a pregelatinized waxy starch, from 0.1% to 75% of vegetable fiber and from 0.1% to 15% of a water activity regulating agent or depressant, at least one sweetener, and water,
cooking the mixture at a temperature of between 100° C. and 150° C. until the desired solids content is obtained,
shaping the cooked mixture so as to obtain jelly confectioneries, and
recovering the jelly confectioneries thus obtained.
